(19) United States
(12) Patent Application Publication
(10) Pub. No.: US 2007/0226300 A1
(43) Pub. Date: Sep. 27, 2007

(54) System and method to prevent the sending of email messages to unqualified recipients

(76) Inventors: Suzelle Smith, Malibu, CA (US); Don Howarth, Malibu, CA (US)

Correspondence Address: Suzelle Smith, Suite 728, 523 West Sixth Street, Los Angeles, CA, 90014, US

(21) Appl. No.: 11/389,585

(22) Filed: Mar. 27, 2006

(51) Int. Cl. G06F 15/16

(52) U.S. Cl. 709/206

(57) ABSTRACT

Improved methods, systems and articles of manufacture for avoiding transmission of an email to unqualified recipients.

### FIELD OF THE INVENTION

The present invention relates in general to data processing systems, and in particular to systems and programs for managing email communications in client systems. Still more particularly, the present invention relates to data processing systems, methods and program products, including electronic mail systems, for informing an email message sender and alternately other network users that an email message has been addressed to an unqualified or unintended recipient or transmission by a client application has been prevented due to the inclusion of an unqualified recipient of the email.

### BACKGROUND OF THE INVENTION

During the past decade, electronic mail (“e-mail”) has become an indispensable tool for facilitating business and personal communications. Through computer networking systems such as local-area networks (LAN), wide-area networks (WAN), and the world-wide-web (WWW), network users can send and receive notes, messages, and letters to communicate with others who are in the same office or perhaps in other locations across the world. More specifically, one conventional manner of producing and sending an email message is to use an email client program (mail client) which combines the functionality of a text editor with a messaging system.

Delivery is solely dependent upon the email message's destination address. This address is comprised of two distinct and functionally different parts, namely the address name and the domain. The domain function of the address is the functional equivalent of a “zip code” and allows a message to be delivered to a specific mail server that is responsible for receiving and storing mail messages for a number of mail clients. The name portion of the address permits the receiving mail server to correctly store the message for retrieval from the particular mail program of the receiver. Typically, the messages are stored at the receiver's mail server until the receiver's email program requests the messages. Some receiver email programs are designed so the program requests and retrieves mail regularly. As is well known, the email address that is supplied by a message sender must be in particular format for successful transmission. The first part of the address is the recipient's user name, followed by a “@” sign, and then a host name or a domain name which identifies where the recipient has an Internet mail account.

In the conventional transmission of an email message, the sender's email client transmits a message to the sender's outgoing mail server. Before the outgoing mail server can send the message to its destination, it must obtain an actual Internet Protocol (IP) address for the recipient's incoming mail server. In other words, the domain portion of the address must be converted into an IP address. In order to obtain the correct IP address for the requested domain, the outgoing mail server communicates with a domain name server (DNS). The DNS will either respond with a destination IP address for the domain's mail server or it will respond that the domain cannot be found. This is a first type of addressing error that can cause a message to be undeliverable. Once the sender's outgoing mail server receives a valid IP address from the DNS, it can and does transmit the message across the Internet to the recipient's incoming mail server. This incoming mail server must then validate the name in the address field. If the name does not exist within that domain, then the recipient's incoming mail server typically causes an error message to be sent to the sender's incoming mail server to inform the sender that the “person” does not exist at that domain. This is the second type of addressing error that causes a message to be undeliverable. If the recipient's incoming mail server correctly validates the name in the address field of the message, then the message is stored in a specific location until the recipient receives it.

It is a relatively common mistake for a user to forget or misspell a user name, host name, or domain name in an email address for an email communication. If such user name, host name, or domain name is invalid, the error is detected during transmission and an error message is generated to be transmitted back to the sender. However, in some alarmingly frequent instances, the user may inadvertently or unintentionally provide a valid user name, host/domain name, in which case, the user may inadvertently communicate information to a recipient which the recipient is unqualified to receive. In the current art the email will be transmitted in the usual course from the user's email server, through the domain name server, on to the Internet, and then received by a valid but unqualified recipient. The problem of inadvertent inclusion of an unintended recipient on an email can result in confidential information being transmitted such as attorney client privileged information, trade secrets and competitively sensitive information, and other private information. One of the problems is that the current technology allows for an error to occur in a fraction of a second which can result in significant economic damage, public embarrassment or worse, criminal self-incrimination.

This problem may be partially alleviated by the use of email software applications including an address directory to assist the user in supplying email addresses when creating email communications. The user can generate entries by supplying names, addresses, telephone and facsimile numbers, email addresses, and other pertinent information into a table. The user can later refer to the directory when composing an email communication. Some email software applications incorporate an automatic email address generator, which, when the user provides the first few characters of an email address, suggests a correct corresponding email address from the list that has been preprogrammed into the directory. Although such an email address directory may alleviate some of the problems outlined above by loading a recipient address automatically into the email message, such a system does not solve the problem of entering an unqualified recipient of an email message where qualification is defined as the addressees predetermined right to view information contained with an email. Further complicating the problem, the address directory itself may and in fact usually does contain valid but unqualified recipient contacts that perpetuate the problem of sending an email message to an unqualified recipient repeatedly. A couple of examples illustrate the magnitude of the problem. Corporation X is being sued by Corporation Y for patent infringement. Counsel for X receives an email from Counsel for Y about some routine litigation matter. Counsel for X responds to Y. Counsel for Y intending to forward the response to the Client with his privileged comments, inadvertently uses the “reply all” icon on his email system. This sends the private communication to opposing counsel without the sender realizing it. Another example, Dr. A is communicating patient information by email to Dr. B also consulting on the case. Dr. A is sent insurance information from the patient's employer by email. Dr. A intending to forward the email to Dr. B with privileged comments about the patient, accidentally accesses the “reply” icon, sending the confidential information to the patient's employer. The negative consequences of these examples illustrate how serious the foreseeable and common error has become. Accordingly, there is a need for a method, system and program for automatically warning when an unqualified recipient is entered into the recipient field of an email message and alternately preventing transmission of said email. Further, there is a need for a system, method and program for informing a message sender when a message has been halted due to the addressing of an unqualified recipient.

### SUMMARY OF THE INVENTION

In accordance with the present invention, improved methods, systems and articles of manufacture for avoiding transmission of an email to unqualified recipients are disclosed. In one embodiment of the present invention, an email client application is used to create an email within a data processing system connected to a network, wherein the email is addressed to a recipient within the network. If it is determined that the recipient is unqualified to receive said email, the email system generates a notification to the sender before transmission and alternately prevents the transmission of the email.

All objects, features and advantages of the present invention will become apparent in the following detailed written description.

### BRIEF DESCRIPTION OF THE DRAWINGS

This invention is described in a preferred embodiment in the following description with reference to the drawings, in which like numbers represent the same or similar elements, as follows:

FIG. 1 illustrates a pictorial representation of a network of an email communication system where the present invention may be advantageously utilized.

FIG. 2 depicts a flow diagram of a process of notifying a user when an email has been addressed to an unqualified recipient, in accordance with the preferred embodiment of the present invention.

FIG. 3 depicts a flow diagram of a process of establishing the qualifications of a potential recipient of email information, in accordance with the preferred embodiment of the present invention.

FIG. 4 depicts one exemplary network arrangement of hardware and software components for notification and prevention of an email message addressed to an unqualified recipient, in accordance with the preferred embodiment of the present invention.

### DETAILED DESCRIPTION OF PREFERRED EMBODIMENTS

The preferred embodiment of this invention is a method, system and program for identifying the qualifications of an addressee of an email message, prior to the transmission of said message. The method, system and program of the preferred embodiment further provides a mechanism for qualification of recipients, notification of email senders that a recipient is an unqualified recipient and means for preventing the transmission of said email which includes an unqualified recipient.

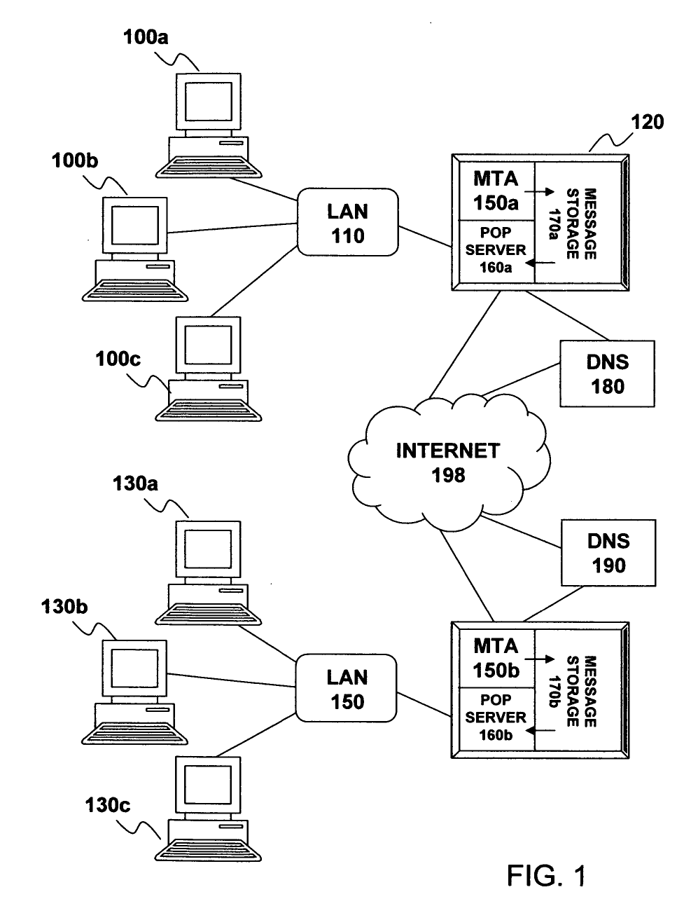

FIG. 1 illustrates a pictorial representation of a network of an email communication system where the present invention may be advantageously utilized. Computers 100a-100c are connected through a local area network (LAN) 110 to email communication system 120, which can send email communications to any of computers 130a-130c through email communication systems 140 and local area network (LAN) 150. Email communication systems 120 and 140 include Mail Transport Agent (MTA) servers 150a, 150b, Post Office Protocol (POP), servers 160a, 160b, and Message Store 170a, 170b. The email communications servers 120 and 140 are also connected to respective domain name servers (DNS) 180, 190.

When an e-mail communication is transmitted according to the Simple Mail Transport Protocol (SMTP), it is first divided into three components: the “mail from:” address; the recipient address list; and the data portion of the message. After a user of computer 100c prepares an e-mail communication and requests transmission of the email the recipient addresses are qualified at by a gateway function 105c and only when all users are validated as qualified recipients of the e-mail will the gateway function 105c allow transmitted across the LAN 110, it is sent to the MTA 150a, which accepts e-mails for delivery. The MTA then separates the address information from the data portion of the email. The MTA parses the envelope to determine whether to route the message to an external network or store the message in Message Store 170a for access by another computer connected to the LAN 110. The MTA “postmarks” the e-mail by adding routing data to the header before storing the message.

If the e-mail is to be sent to a another user on a different mail system, the MTA 150a next determines the domain for the intended recipient through the DNS 180, which queries the DNS 190 through the Internet 198. Upon receiving the domain information, MTA 150a transmits the e-mail communication to the MTA 150b, which is waiting to accept e-mail. The MTA 150b then stores the received e-mail in Message Store 170b. Later, a user on computer 130a logs in to the e-mail system and connects to the POP server 160b, which determines if there is new mail to download. The POP server 160b retrieves the e-mail communication from the Message Store 170b and transmits the e-mail through the LAN 150 to the user.

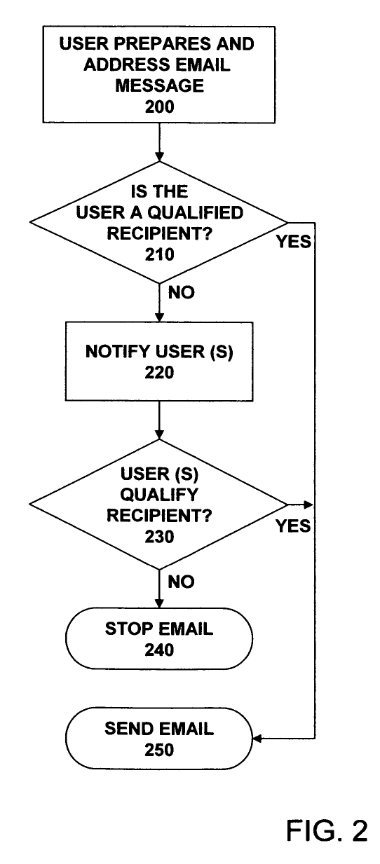

With reference now to FIG. 2, there is depicted a flow diagram of a process for unqualified recipient notification, in accordance with the preferred embodiment of the present invention. The process is implemented in an email communications client within a sender computer system, and begins when an email message is created at the sender's (user's) computer system as shown in step 200. The process passes to a step where the Qualification Gateway 210 determines if the user is an unqualified recipient of the created email. For example, the Qualification Gateway 210 may determine that the message recipient is not within a defined domain set which could compromise attorney client relationships, Health Insurance Portability and Accountability Act (HIPAA) regulations or like privileged information. This process step 210 could also be performed by the computer in a preferred embodiment. In an alternative preferred embodiment, the email client on the user's computer would include logic to search the messages for other information used in qualifying a given recipient. If there is a variance between the computer user's email and those names identified as qualified by the qualification gateway 210, the email client will prevent transmission of the email and inform at least the user that the message contains unqualified addresses. If the determination at step 210 is that an addressee is a qualified recipient of the email message, the process terminates at step 250 and the email is transmitted. If it is determined at step 210 that the user is an unqualified recipient of the email message, the process proceeds to step 220 notify one or more users of an initial attempt to communicate with an unqualified recipient action and holding off the email communication in client application. Step 230 depicts one embodiment of a request for qualification of an email in response to notification as in step 220 recipient to the original sender of the email message received at step 210 and optionally requiring multiple qualifying agents to establish an email recipients as a qualified email recipient either by direct command or by establish rules which are executed at step 210. If the user is not qualified by a user, a group of users, a hierarchy of users or rules established by any of the proceeding users the email is not transmitted and halted in step 240.

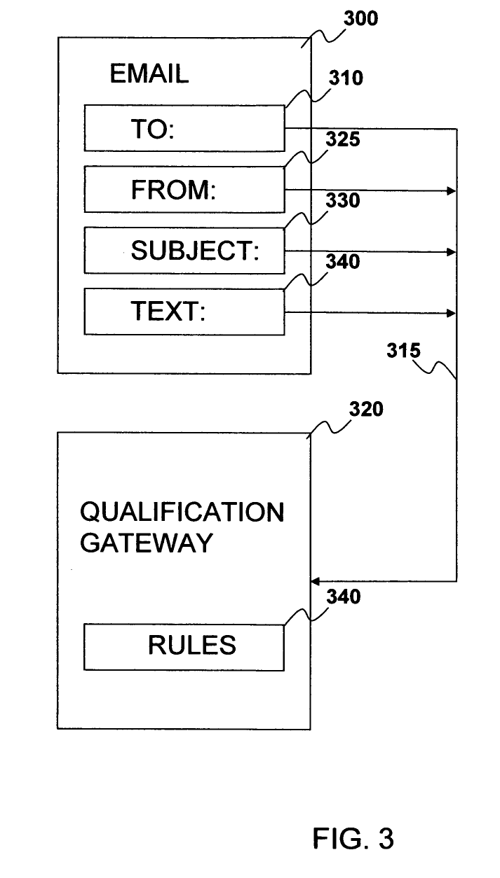

FIG. 3 depicts a flow diagram of a method of establishing the qualifications of a potential transmission recipient, in accordance with one preferred embodiment of the present invention. Qualification requests 300 including a “To:” line 310 indicating the addressee of the recipient to be qualified, which in accordance with the preferred process are received by the qualification gateway 320, from the sender of the email message. Qualification requests 315 can optionally include a “From:” line 325 identifying the sender of the original email message an be used as part of the qualification in step 320. An email also may include a subject line 330 referencing the original email, and a text body 340 providing a message to the original sender and other recipients. This standard text in body 340 could be automatically included in a series of qualifying rules executed by the Qualification Gateway 320 or established by direct input as from the sender as a global qualification. For example, the standard text could say “This email outlines deposition preparation”, at the email client a sender may address this email to John.Doe@megacorp.com. While the sender may not recognize that the addressee is unqualified to receive said email communication the qualification gateway in a preferred embodiment notifies the sender of all addressees which are unqualified as defined by the rules of the qualification gateway. In this example the qualification criteria may be as simple as all addressees outside of the sender's domain are unqualified. One the sender is notified of the intended unqualified recipient of the email the user can then determine if the qualification status of the addressee can conditionally be changed for this specific email. In some embodiments other users of the network will be notified of the transmission request and ensure that recipients are correctly qualified and that rules for qualifying recipients are properly defined.

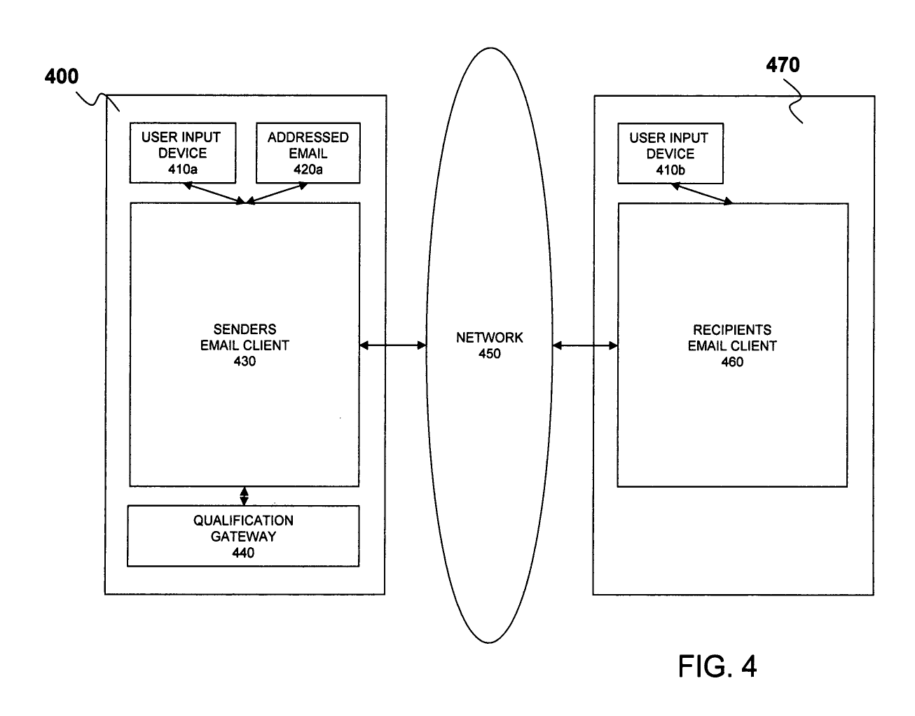

With reference now to FIG. 4, there shown one exemplary network arrangement of hardware and software components for warning of an email message addressed to an unqualified recipient, in accordance with the preferred embodiment of the present invention. Data processing system 400 is utilized by a sender of an original email via an input device 410, included as one of the recipients addressed within email 420 may be a user of secondary data processing system 470 which is unqualified to receive the original e-mail 420. Prior to the transmission of said email the sender's email client application 430 employing a qualification gateway 440 notifies the user via the data processing system 400 of an unqualified recipient, once the user has qualified the recipient in response to the notification initiated by said qualification gateway 440 the original email 420 is transmitted over network 450 to be received at a secondary data processing system 470 by the now qualified recipient email client 460 executing within data processing system 470.

One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. A method for avoiding transmission of an email to an unqualified recipient, the method comprising the steps of: creating an email within a data processing system connected to a network, wherein the email is addressed to one ore more recipients within a network; determining that the recipient is qualified to receive said email; the prevention of the email transmission and generation of a notification of a recipients status as unqualified to receive said email.

2. The method according to claim 1, wherein the step of determining includes accessing an electronic address book and determining if an entry in the address book corresponding to the recipient indicates the recipient is a potential unqualified recipient.

3. The method according to claim 2, further comprising the step of qualifying said recipient in response to a determination and notification that an email addressed and sent to a recipient had been an qualified recipient.

4. The method according to claim 1, wherein the notification is a message displayed on a display device within the data processing system.

5. The method according to claim 1, further comprising the step of permitting the notification of one or more unqualified recipients to be provided to one or more users of the network.

6. The method according to claim 1, wherein the step of determining includes receiving a command resulting from user input and execution of a predetermined set of rules by the data processing system, wherein the email generated is determined to be addressed to an unqualified recipient.

7. The method according to claim 1, wherein the steps of claim 1 are performed by an email client executing within the data processing system.

8. A system for avoiding transmission of an email to an unqualified recipient, said system comprising: means for creating an email within a data processing system connected to a network, wherein the email is addressed to a recipient within the network; means for determining that the recipient has been designated as an unqualified email recipient; and means for generating a notification to the creator of said email.

9. The system according to claim 8, wherein the means for determining includes means for applying rules corresponding to the qualification of the email recipient.

10. The system according to claim 9, further comprising means for defining the rules for determination that an email recipient is a qualified recipient.

11. The system according to claim 8, wherein the notification is a message displayed on a display device within the data processing system.

12. The system according to claim 8, further comprising means for permitting the email to be addressed to one or more other recipients instead of or in addition to the recipient in response to the notification.

13. The system according to claim 12, further comprising means for creating an entry associated with the recipient in an electronic address book that indicates the recipient had previously been a qualified recipient of an email.

14. An article of manufacture comprising machine-readable medium including program logic embedded therein for avoiding transmission of an email to an unqualified recipient that causes control circuitry in a data processing system to perform the steps of: creating an email within a data processing system connected to a network, wherein the email is addressed to a recipient within the network; determining that the recipient has been designated as a potential unintended email recipient; and generating a notification that the recipient is an unqualified recipient of the email.

15. The article of manufacture of claim 14, wherein the step of determining includes accessing an electronic index and determining if an entry in the index corresponding to the recipient indicates the recipient is a qualified recipient.

16. The article of manufacture of claim 15, further comprising the step of creating rules to be applied in the determination that an email has been addressed to an unqualified recipient.

17. The article of manufacture of claim 14, wherein the notification is a message displayed on a display device within the data processing system.

18. The article of manufacture of claim 14, further comprising the step of permitting the email to be addressed to one or more other recipients instead of or in addition to the recipient in response to the notification.

19. The article of manufacture of claim 14, wherein the step of determining includes receiving a command resulting from user input and execution of a predetermined set of rules by the data processing system, wherein the email generated is determined to be addressed to an unqualified recipient.
